(19) United States
(12) Patent Application Publication
(10) Pub. No.: US 2023/0234285 A1
(43) Pub. Date: Jul. 27, 2023

(54) NOZZLE DEVICE FOR FDM-TYPE 3D PRINTER

(71) Applicant: BIOFRIENDS INC., Seoul (KR)

(72) Inventors: Dong Nyoung HEO, Seoul (KR); Il Keun KWON, Seoul (KR)

(21) Appl. No.: 18/010,805

(22) PCT Filed: Jun. 7, 2021
(86) PCT No.: PCT/KR2021/007079

§ 371 Date: Dec. 15, 2022

(30) Foreign Application Priority Data
Jun. 16, 2020 (KR) 10-2020-0073069

(51) Int. Cl. B29C 64/209; B29C 64/118; B29C 64/295; B29C 64/364

(52) U.S. Cl. CPC B29C 64/209; B29C 64/118; B29C 64/295; B29C 64/364; B33Y 10/00

(57) ABSTRACT

One embodiment of the present disclosure provides a nozzle device for an FDM-type 3D printer, comprising: a filament supply unit to which a filament for FDM is supplied; a filament nozzle which is positioned on the lower part of the filament supply unit, and which melts the filament received from the filament supply unit so as to output the molten filament; a heater block provided on the circumference of the filament nozzle to melt the filament inside the filament nozzle; a humidifier for generating vapor; and a transfer pipeline, which transfers the vapor of the humidifier to spray same onto the molten filament.

### TECHNICAL FIELD

The present disclosure relates to a nozzle device for a FDM-type 3D printer, and more particularly, to a nozzle device for a FDM-type 3D printer, the device having a humidifier as a cooling unit.

### BACKGROUND ART

An FDM-type 3D printer, which manufactures an object by semi-melting solid plastic materials at high temperatures, employs a method in which a filament-type material is injected with increased temperature of a nozzle and layers are formed with the output material to manufacture a three-dimensional object, and by breaking away from the existing manufacturing methods such as mold and injection, it is possible to drastically reduce the cost of manufacturing a prototype.

The FDM-type 3D printer is used in various fields such as culture, art, architecture, and design, and recently, there is a movement to use the FDM-type 3D printer in operating rooms. In detail, tissue regeneration using general 3D printing may be applied when a treatment period is sufficient or when there is no urgency; however, when rapid bone tissue reconstruction is required or when there is a risk of infection in the process of manufacturing a scaffold from the outside, a method of directly printing a scaffold on a patient's damaged body part is required.

However, the melting point of polycaprolactone (PCL), which is widely used as a filament to substitute for bone tissue, is about 60˜100° C. that is lower than the melting point (180˜210° C.) of polylactic acid (PLA) and the melting point (200-230° C.) of acrylonitrile butadiene steel (ABS), but still it is not possible to directly print PCL on a patient's body part during a surgery due to concerns about tissue damage or burns.

In addition, the existing FDM-type 3D printers have a problem in that a nozzle is often clogged. The vicinity of the nozzle is maintained at a very high temperature in order to melt a filament, which is a base material, and when the temperature around the nozzle is transferred to an upper part of the nozzle, a supply unit from which the filament is supplied is heated together. As a result, the filament in the supply path melts and overflows, and after cooling, the melted filament is solidified, thereby clogging the nozzle. In particular, when PCL is used as a filament, it is necessary to effectively dissipate heat around the filament supply unit because PCL has a melting point lower than that of other materials, as described above.

In order to solve this problem, a cooling fan or the like may be installed in the filament supply unit and the filament nozzle, but the cooling fan not only lowers the temperature of the molten filament output from the nozzle but also lowers the temperature of the nozzle unit, resulting in a decrease in thermal efficiency, and there is another problem that the internal structure of the 3D printer becomes more complicated due to the installation of the cooling device.

### DISCLOSURE

### Technical Problem

The present disclosure provides a nozzle device for an FDM-type 3D printer to solve the above problems, purpose of the device capable of rapidly cooling a molten filament output from a filament nozzle to print a scaffold directly on a patient's damaged body area.

The present disclosure also provides a nozzle device for a FDM-type 3D printer, the nozzle device capable of efficiently dissipate heat transferred to a filament supply unit while rapidly cooling a molten filament output from a filament nozzle.

### Technical Solution

In one aspect, there is provided a nozzle device for a FDM-type 3D printer, the device including: a filament supply unit to which a filament for FDM is supplied; a filament nozzle positioned under the filament supply unit and melting the filament supplied from the filament supply unit to output the molten filament; a heater block installed around the filament nozzle to melt the filament inside the filament nozzle; a humidifier configured to generate water vapor; and a transfer pipe for transferring water vapor from the humidifier and spraying the water vapor to the molten filament.

In one embodiment, an end of the transfer pipe may be directed toward a lower end of the filament nozzle, and the molten filament may be cooled by the water vapor as soon as being output from the filament nozzle.

In one embodiment, the molten filament may be cooled to a temperature of 41° C. or less.

In one embodiment, the filament may be formed of polycaprolactone (PCL).

In one embodiment, a spray amount of the humidifier may be 100 to 150 cc/h.

In one embodiment, the transfer pipe may wrap around the filament supply unit.

In one embodiment, a heat dissipation unit may be disposed on an outer periphery of the filament supply unit, the heat dissipation unit may be formed as a helical concavo-convex portion, and the transfer pipe may wrap around the filament supply unit along the heat dissipation unit.

In one embodiment, a cross section of the helical concavo-convex portion may be of a rectangular screw thread and a rectangular screw root.

In one embodiment, a diameter of the transfer pipe may be greater than or equal to a diameter of the helical concavo-convex portion.

In one embodiment, the heat dissipation unit and the transfer pipe may be formed of a Teflon material.

### Advantageous Effects

According to one aspect of the present disclosure, the humidifier sprays water vapor toward the molten filament output from the filament nozzle to rapidly cool the molten filament, so that the scaffold is directly printed on the damaged area of the patient without fear of tissue damage or burns.

In addition, by wrapping the transfer pipe through which water vapor flows in the filament supply unit, it is possible to efficiently dissipate heat transferred to the filament supply unit without a separate cooling fan.

That is, it is possible to quickly cool a molten filament output from a filament nozzle and also efficiently dissipate the heat transferred to the filament supply unit.

Effects of the present disclosure are not limited to the above effects, and it should be construed that the effect of the present invention includes all effects which can be inferred from the constitution of invention described in the detailed description or claims of the present invention.

### DESCRIPTION OF DRAWINGS

FIG. 1 is a perspective view of a nozzle device for a FDM-type 3D printer according to an embodiment of the present disclosure.

FIG. 2 is a cross-sectional view of FIG. 1.

FIG. 3 is a configuration diagram in which a humidifier is added to FIG. 1.

FIG. 4(A) is an image captured by a thermal imaging camera of PCL output in the absence of a humidifier, FIG. 4(B) is an image captured by a thermal imaging camera of PCL output in the presence of a humidifier, and FIG. 4(C) is a graph showing PCL temperatures of FIGS. 4(A) and 4(B).

FIG. 5(A) is an image captured by a thermal imaging camera of PCL output from three groups of filament nozzles, and FIG. 5(B) is a graph showing PCL temperatures measured in the three groups.

FIG. 6(A) is a filament diameter of a PCL scaffold printed in the presence of a humidifier, and FIG. 6(B) is a scanning electron microscope image of a printed PCL scaffold when a printing speed is 3 mm/sec.

FIG. 7 is an image showing the compressive modulus of a PCL scaffold printed in the presence of a humidifier.

FIG. 8(A) is a uCT image of a rat with a calvaria defect, FIG. 8(B) shows PCL printed on the calvaria defect, FIG. 8(C) is an H&E staining image of soft tissues of the rat subject to printing in the absence of a humidifier, and FIG. 8(D) is an H&E staining image of soft tissue of a rat subjected to printing in the presence of a humidifier.

### MODE FOR DISCLOSURE

Hereinafter, the present disclosure will be described with reference to the accompanying drawings. However, the present disclosure may be modified in various different ways, and the present disclosure is not limited to the described exemplary embodiments. Moreover, the part not related to the description will be omitted in order to clearly describe the present disclosure, and like reference numerals designate like elements throughout the specification.

In the specification, when a part is “connected” with other parts, it includes “direct connection” as well as “indirect connection” in which the other member is positioned between the parts. In addition, unless explicitly described to the contrary, the word “comprise”, such as “comprises” or “comprising” will be understood to imply the inclusion of stated elements but not the exclusion of any other elements.

Hereinafter, embodiments of the present disclosure will be described in detail with reference to the accompanying drawings.

A nozzle device for a 3D printer according to a first embodiment of the present disclosure includes a filament supply unit 200, a filament nozzle 100, a heater block 300, and a humidifier 400.

First, the filament supply unit 200 is configured as a tube of a certain diameter. The filament nozzle 100 is positioned at a lower end of the filament supply unit 200. A tube having a diameter equal to that of the filament supply unit 200 is formed at one end of the filament nozzle 100, and a nozzle tip having a gradually decreasing diameter is formed at the other end. In addition, the filament nozzle 100 is open toward the bottom. In addition, a heater block 300 for melting a filament in the filament nozzle 100 is positioned around one end of the filament nozzle.

In detail, the filament supply unit 200 communicates with the filament nozzle 100 from which the molten filament F is output, and the filament in the form of a thread is supplied from a supply module (not shown) to the filament supply unit 200 and then supplied to the filament nozzle 100, and the filament is melted while passing through the heater block 300 positioned around the filament nozzle 100.

Meanwhile, the present disclosure includes the humidifier 400 for cooling the molten filament F output from the filament nozzle 100. Preferably, one end of the humidifier may be connected to the humidifier 400, and the other end of the humidifier may include a transfer pipe 500 toward the molten filament F. Water vapor generated in the humidifier 400 is transferred to the other end of the transfer pipe 500 along the transfer pipe 500 and is sprayed toward the molten filament F.

Preferably, the other end of the transfer pipe 500 may be headed the lower end of the filament nozzle 100. Accordingly, the molten filament F may be cooled by water vapor as soon as being output from the filament nozzle 100, and also the cooling of the molten filament F does not affect the temperature of the filament nozzle 100, thereby improving the thermal efficiency.

Meanwhile, preferably, the present disclosure may include an adjusting member (not shown) capable of adjusting an angle and a position of the transfer pipe 500. By the adjusting member, a plasma nozzle positioned at an end of the transfer pipe 500 may be directed to a lower portion of the filament nozzle 100, and the transfer pipe 500 may be separated from the heater block 300.

More preferably, the adjusting member may be provided in the filament supply unit 200. In this case, the transfer pipe 500 is fixed by the adjusting member provided in the filament supply unit 200 and thus dependent on a movement of the filament supply unit 200.

Accordingly, the transfer pipe 500 moves along with the filament nozzle 100, and thus, regardless of a moving direction of the filament nozzle 100, the molten filament F may be cooled as soon as being output from the filament nozzle 100.

More preferably, a spray amount of the humidifier 400 may be set to 100 to 150 cc/h, but aspects of the present disclosure are not limited thereto.

Meanwhile, although the above-described PLA, ABS, and the like may be used as the filament, it is most preferable to use PCL having the lowest melting point and excellent biodegradability as the filament.

In addition, it is preferable to cool the molten filament F to a temperature of 41° C. or less so that tissues are not damaged or burns even when printing is performed directly on a patient's body part during a surgery.

Meanwhile, an experiment was conducted to see the filament cooling effect according to the humidifier 400 of the present disclosure.

### Experiment 1

In detail, the temperature of the PCL output from the filament nozzle 100 was measured with a thermal imaging camera in cases where the humidifier 400 was present and where the humidifier 400 was absent. At this time, the temperature of the heater block 300 was set to 65-68° C., and 150 cc/h of water vapor was generated as tertiary distilled water at room temperature and sprayed to the output PCL.

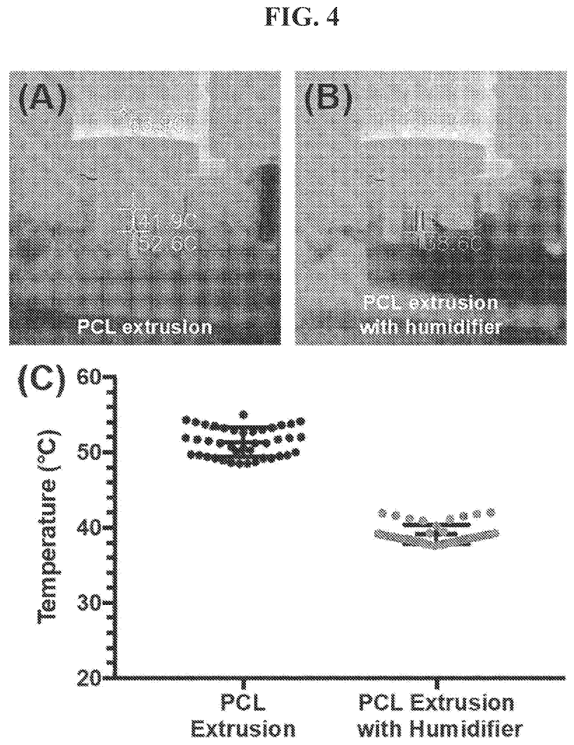

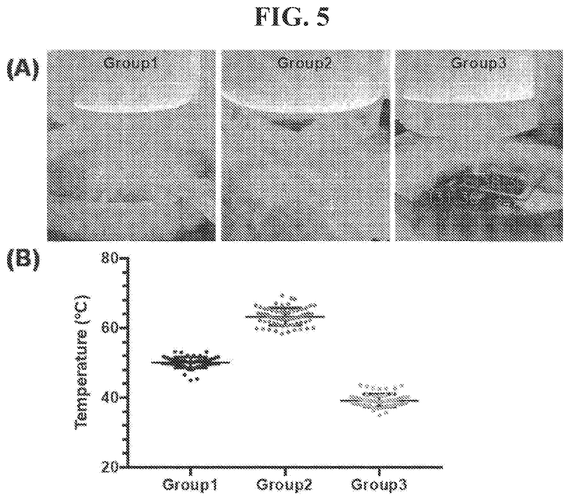

As a result of the experiment, as shown in FIG. 4, the PCL output in the absence of the humidifier 400 was measured at a temperature of 51.3° C.±1.9, but the PCL output in the presence of the humidifier 400 was measured at a temperature of 39.1° C.±1.3.

That is, it is possible to effectively cool the molten PCL according to the humidifier 400 of the present disclosure.

In addition, when printing is performed directly on the patient's body part during a surgery, a temperature of molten PCL was measured in three groups under the same conditions as Experiment 1 to see the effect of the cooling unit of the present disclosure.

### Experiment 2

Specifically, printing was performed in the absence of the humidifier 400 in Group 1 under the condition where a temperature of the bottom of the printer was maintained at room temperature; printing was performed in the absence of the humidifier 400 in Group 2 under the condition where a temperature of the bottom of the printer was maintained at 37° C. similar to body temperature; and printing was performed in the presence of the humidifier 400 in Group 3 under the condition where a temperature of the bottom surface of the printer was maintained at 37° C. similar to body temperature.

As a result of the experiment, as shown in FIG. 5, a temperature of the melt PCL of Group 1 was measured at 50.1° C.±1.5, a temperature of melt PCL of Group 2 was measured at 63.3° C.±2.5, and a temperature of melt PCL of Group 3 was measured at 39.2° C.±1.8.

That is, even in the case of performing printing directly on a patient's body part during a surgery, it is possible to effectively cool the molten PCL with the humidifier 400 of the present disclosure.

In addition, in order to see a diameter and a compressive modulus of PCL according to a printing speed, printing was performed at different speeds of 2, 2.5, 3, 3.5, and 4 mm/sec under the same conditions as in Experiment 2.

### Experiment 3

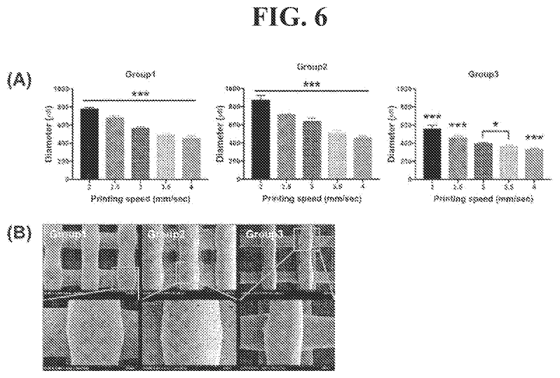

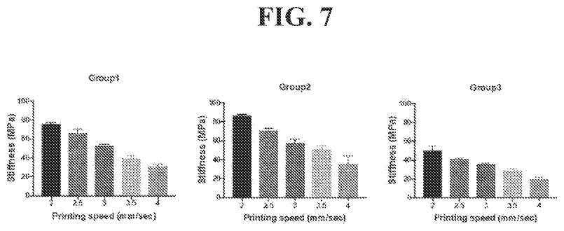

As a result of the experiment, as shown in FIGS. 6 and 7, it was found that the higher the printing speed, the smaller the filament diameter of the PCL scaffold and the lower the compressive modulus. In addition, it was found that, at the same printing speed, the filament diameter was smaller than the case where the humidifier 400 was not present.

That is, when the molten PCL is cooled by the humidifier 400, it is possible to print more precisely because the filament diameter is small

In addition, an animal experiment was conducted to determine whether tissue damage occurs when PCL output by using the 3D printer connected to the humidifier 400 is printed on actual tissues.

### Experiment 4

Specifically, after a calvaria defect with a diameter of 6 mm was made in the skull of an 8-week-old female mouse, PCL was directly printed on dura mater, which is soft tissue located under a removed skull. After the printing is performed, the defect was sutured and the tissue damage was evaluated by Haemotoxylin and Eosin (H&E) staining 48 hours later.

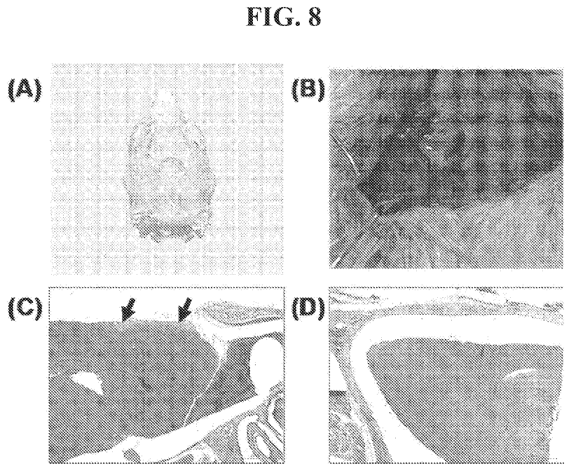

As a result of the experiment, as shown in FIGS. 8(C) and 8(D), tissue damage of soft tissues (dura mater, arachnoid, pia mater, and brain) was observed in a PCL printing group in which the humidifier 400 was not operated, whereas soft tissue damage was not observed in a PCL printing group in which the humidifier 400 was operated.

That is, using the humidifier 400 of the present disclosure, a temperature of the PCL output from the filament nozzle 100 may be effectively cooled, and even if the PCL is directly printed on the patient's body part during a surgery, there is no risk of tissue damage or burns.

Next, a nozzle device for a 3D printer according to a second embodiment of the present disclosure will be described. Using the transfer pipe 500 and the humidifier 400 according to the second embodiment, it is possible not only to cool the molten filament F output from the filament nozzle 100 of the above-described embodiment, but also to cool the filament supply unit 200.

In this regard, when the heat of the filament nozzle 100 heated by the heater block 300 is transferred to the filament supply unit 200 positioned at the top, the filament may melt and overflow before the filament is transferred to the inside of the filament nozzle 100, and after cooling, the melted filament may be solidified, thereby clogging the nozzle.

However, since the transfer pipe 500 of the present disclosure wraps and cools the filament supply unit 200, the above phenomenon may be prevented.

In detail, the heat supplied by the heater block 300 is directly transferred to a filament supply pipe, increasing the temperature of the filament supply pipe. In this case, the water vapor generated in the humidifier flows inside the transfer pipe 500, and thus, when the transfer pipe 500 wraps the filament supply unit 200, the heat transferred to the filament supply unit 200 is transferred to the transfer pipe 500 and water vapor inside the transfer tub 500. That is, it is possible to efficiently dissipate the heat of the filament supply pipe through the water vapor inside the transfer pipe 500.

In this case, the temperature of the water vapor transferred through the transfer pipe 500 rises, so in order to cool the molten filament F output from the filament nozzle 100, it is preferable to decrease the temperature of the water vapor generated from the humidifier 400.

Meanwhile, the heat dissipation unit 600 and the transfer pipe 500 should be formed of a material having a strong ability to withstand and dissipate heat, that is, a material with strong heat resistance. This is because the heat dissipation unit 600 should withstand the heat transmitted from the filament nozzle 100 and dissipate the heat again through the transfer pipe 500 Thus, the heat dissipation unit 600 and the transfer pipe 500 are preferably formed of Teflon having excellent heat resistance, but aspects of the present disclosure are not limited thereto, and he heat dissipation unit 600 and the transfer pipe 500 may be formed of other materials having excellent heat resistance.

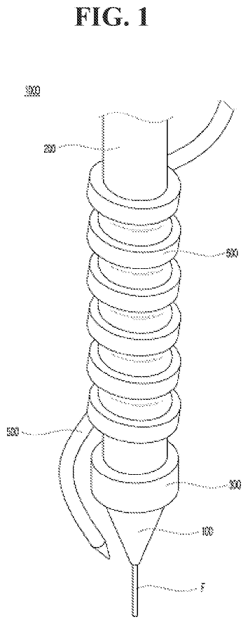

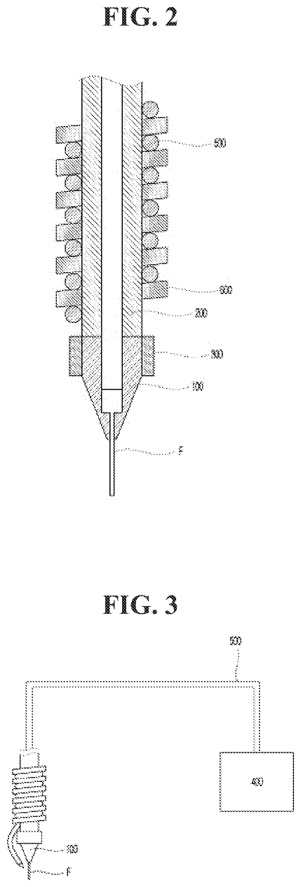

Preferably, as shown in FIGS. 1 and 2, a helical concave-convex portion 700 protruding outward is formed in an outer periphery of the filament supply unit 200 as a heat dissipation unit 600, and the transfer pipe 500 may wrap around the filament supply unit 200 along the concave-convex portion.

Accordingly, an area where the filament supply unit 200 and the transfer pipe 500 contact each other may be expanded, and the heat transferred to the filament supply unit 200 by the heater block 300 may be more efficiently dissipated.

More preferably, the helical concave-convex portion 700 is composed of a rectangular screw thread and a rectangular screw root having a rectangular cross section, and a diameter of the transfer pipe 500 may be greater than or equal to a diameter of the helical concave-convex portion 700.

In detail, when the cross section of the helical concave-convex portion 700 is rectangular, the transfer pipe 500 is inserted into the helical concave-convex portion 700 to enlarge an area in contact with the helical concave-convex portion 700, and thus, heat transfer efficiency may be increased. In addition, since the diameter of the transfer pipe 500 is greater than the diameter of the helical concave-convex portion 700, when the transfer pipe 500 is inserted into the helical concave-convex portion 700, it is possible to fix the transfer pipe 500 to the helical concave-convex portion 700 without any fixing member.

In summary, in the nozzle device for a 3D printer according to the second embodiment of the present disclosure, it is possible to quickly cool the molten filament F, output from the filament nozzle 100, using the humidifier 400 and the transfer pipe 500 and also efficiently dissipate heat transferred to the filament supply unit 200.

The above description of the present disclosure is for illustrative purposes, and it will be understood by those skilled in the art that various changes in form and details may be made therein without departing from the spirit and scope of the present disclosure as defined by the appended claims. Therefore, the foregoing embodiments should be understood as being illustrative but not limitative purposes. For example, some parts described as being located in a single physical entity can be implemented as being distributed to a plurality of physical devices, and in the same fashion, some parts described as being distributed to a plurality of physical devices can be located in a single physical entity.

The scope of the present disclosure is defined not by the detailed description but by the appended claims, and all modifications and alterations derived from the concept, the range, and the equivalents of the claims will be construed as being included in the scope of the present disclosure.

### DETAILED DESCRIPTION OF MAIN ELEMENTS

100: filament nozzle

200: filament supply unit

300: heater block

400: humidifier

500: transfer pipe

600: heat dissipation unit (helical concavo-convex portion)

1000: nozzle device for FDM-type 3D printer

F: molten filament

1. A nozzle device for an FDM-type 3D printer comprising:
a filament supply unit to which a filament for FDM is supplied;
a filament nozzle positioned under the filament supply unit and melting the filament supplied from the filament supply unit to output the molten filament;
a heater block installed around the filament nozzle to melt the filament inside the filament nozzle;
a humidifier generating water vapor; and
a transfer pipe for transferring water vapor from the humidifier and spraying the water vapor to the molten filament.

2. The nozzle device of claim 1, wherein an end of the transfer pipe is directed toward a lower end of the filament nozzle, and the molten filament is cooled by the water vapor as soon as being output from the filament nozzle.

3. The nozzle device of claim 1, wherein the molten filament is cooled to a temperature of 41° C. or less.

4. The nozzle device of claim 3, wherein the filament is formed of polycaprolactone (PCL).

5. The nozzle device of claim 1, wherein a spray amount of the humidifier is 100 to 150 cc/h.

6. The nozzle device of claim 1, wherein the transfer pipe wraps around the filament supply unit.

7. The nozzle device of claim 6, wherein:
a heat dissipation unit is disposed on an outer periphery of the filament supply unit,
the heat dissipation unit is formed as a helical concavo-convex portion, and
the transfer pipe wraps around the filament supply unit along the heat dissipation unit.

8. The nozzle device of claim 7, wherein a cross section of the helical concavo-convex portion is of a rectangular screw thread and a rectangular screw root.

9. The nozzle device of claim 8, wherein a diameter of the transfer pipe is greater than or equal to a diameter of the helical concavo-convex portion.

10. The nozzle device of claim 7, wherein the heat dissipation unit and the transfer pipe are formed of a Teflon material.
